(19) United States
(12) Patent Application Publication
(10) Pub. No.: US 2008/0310451 A1
(43) Pub. Date: Dec. 18, 2008

(54) Splitting of a Data Stream

(75) Inventors: I-Chih Kang, Eindhoven (NL); Ewout Brandsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/097,940

(22) PCT Filed: Dec. 20, 2006
(86) PCT No.: PCT/IB06/54972

§ 371 Date: Jun. 18, 2008

(30) Foreign Application Priority Data
Dec. 23, 2005 (EP) 05112883.3

(51) Int. Cl. H04J 3/24

(52) U.S. Cl. 370/474

(57) ABSTRACT

The present invention relates to a method of splitting a data stream into packets which comprise either only video units or only non-video units in order to better enable the enhancement of a displayed video stream using IFD without causing any audio artifacts. The gist of the present invention is the insight and the realisation of splitting the data stream into smaller packets than is customary. Thus it becomes possible to produce packets comprising either video units or non-video units, and in case of video units, packets pertaining to only one video frame.

The present invention relates to a method of, and a device for, splitting a data stream into packets, said data stream comprising video units and non-video units. It also relates to a computer program for carrying out the method, a record carrier comprising the computer program, a transmitter comprising a device for splitting a data stream into packets, and a method of transmitting video units and non-video units being comprised in a data stream.

Home networks connect personal computers, telephones, and consumer electronic devices. Cabling is usually undesired, so wireless networks and devices are increasing in popularity. A disadvantage of the wireless medium is its sensitivity to transmission conditions. When the bandwidth of the network is reduced and not sufficient to transmit the entire stream, packets are lost and the impact on e.g. displayed video and audio can be quite detrimental. In order to reduce or even completely remove all these unwanted effects, different techniques have been proposed to try to control that part which is thrown away. One of these techniques, dealing with video streams, is a network scheduling technique, called I-Frame Delay (IFD) (see “Adaptive Scheduling of MPEG Video Frames during Real-Time Wireless Video Streaming”, S. Kozlov, P. van der Stok, and J. Lukkien, Proceedings of WoWMoM, Jun. 13-16, 2005). IFD drops video frames when detecting that the available bandwidth is insufficient to transmit the entire video stream. This dropping is done in such a way that the least important frames are dropped first (B-frames), thus strongly reducing the occurrence of artifacts at the receiver side, which is the effect of otherwise losing (parts of) more important frames (I- and P-frames).

However, in consumer electronics devices there is usually audio associated with the video stream. A simple solution is to send the audio stream separately from the video stream, and apply e.g. IFD on the video stream only. The audio is given a higher priority over the video stream during transmission because people are more sensitive to audio artifacts. However, in the case that the multimedia content comes into the home via broadcast, e.g. DVB, the streams used are typically MPEG-2 transport streams, in which the audio and video units are multiplexed together with some other system data. Demultiplexing the broadcast transport streams into audio and video elementary streams before streaming over the in-home network requires more processing power in the home gateway, and moreover the extra information is lost (e.g. subtitles). Therefore it is best to stream the transport streams directly over the home network without demultiplexing.

An object of the present invention is therefore to overcome the above-mentioned limitations.

The object is achieved by splitting said data stream into packets which comprise either only video units or only non-video units.

The data stream comprises video units and non-video units, such as audio and data units, which are interleaved in a typical multiplexed stream structure. By splitting the data stream as it is being streamed into packets which comprise either only video units or only non-video units, it thus becomes possible to separately deal with respective units. The displayed video stream may consequently be enhanced by IFD without causing any audio artifacts on the audio stream. The implementation of the present invention only involves changes at the data stream transmitter; standard receivers may be used.

The gist of the present invention is the insight and the realisation of splitting the data stream into smaller packets than is customary. Thus it becomes possible to produce packets comprising either video units or non-video units, which may be dealt with separately. Furthermore, the different video units pertaining to different video frames are also separated, for use by IFD.

The above-mentioned object is also achieved by a device for splitting the data stream into packets, said data stream comprising video units and non-video units. The object is further achieved by a computer program for carrying out the method, by a record carrier comprising the computer program, by a transmitter comprising a device for splitting said data stream into packets, and by a method of transmitting video units and non-video units being comprised in a data stream.

In a preferred embodiment of the present invention the method of splitting said data stream comprises allocating a present unit to a new packet if only one of the present unit and a directly preceding unit is a video unit.

The multiplexed data stream is received in a stream of video, audio and data units. By starting a new packet by assigning a present unit to that packet if the present unit or a directly preceding unit is a video unit, the video units are thus split, or separated, from the non-video units.

In another preferred embodiment of the present invention the method of splitting said data stream comprises allocating a present unit to a new packet if the number of units already allocated to a directly preceding packet is equal to a preset number.

In packet-switched networks there are rules for the maximum packet sizes that can be transmitted over the network interfaces. On Ethernet the maximum packet size is 1500 bytes. When streaming with e.g. the RTP (Real-time Transport Protocol) protocol, it has been specified how to packetize transport stream units, equally sized 188 bytes, into RTP units. The conventional way is to take 7 transport stream units and pack them into a single RTP packet, thus making the payload size 1316 bytes. By allocating a present unit to a new packet if the number of units already allocated to a directly preceding packet is equal to a preset number, the maximum packet size will never be exceeded.

In another preferred embodiment of the present invention the method of splitting said data stream comprises allocating a present unit to a new packet if the present unit and the previous unit are both video-units, but pertaining to different video frames.

The packet may comprise units which belong to several frames, and if e.g. IFD is to be applied on the split data stream, parts of multiple frames may be dropped at the same time, thus causing potential video artifacts. Assigning video units, which belong to different frames, to different packets, diminishes this risk.

Further features and advantages of the present invention are recited in the attached claims, the disclosure of which is incorporated herein by reference, and to which the reader is now directed.

Preferred embodiments of the present invention will now be described, by way of example only, and with reference to the accompanying drawings, in which:

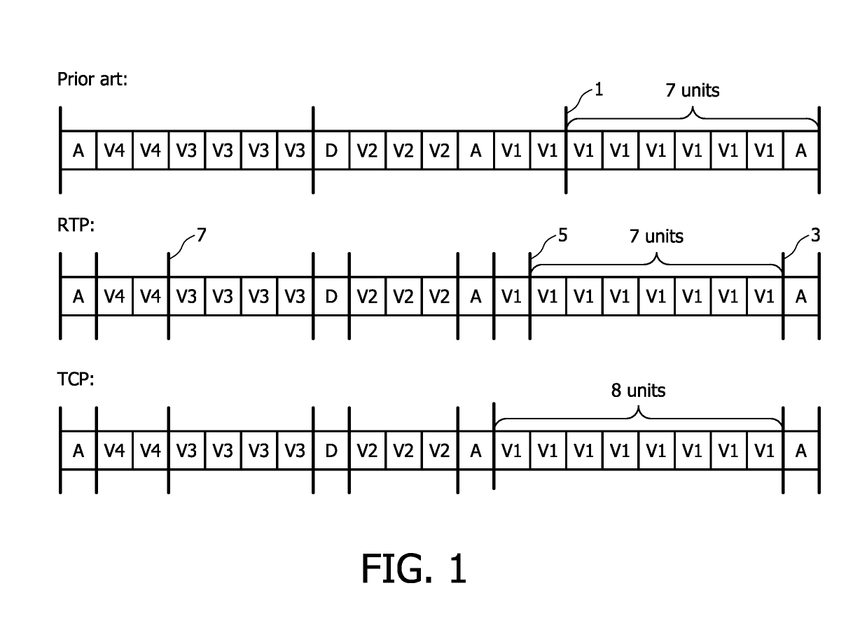

FIG. 1 shows three examples of a data stream and the packet boundaries after applying the splitting method according to the present invention.

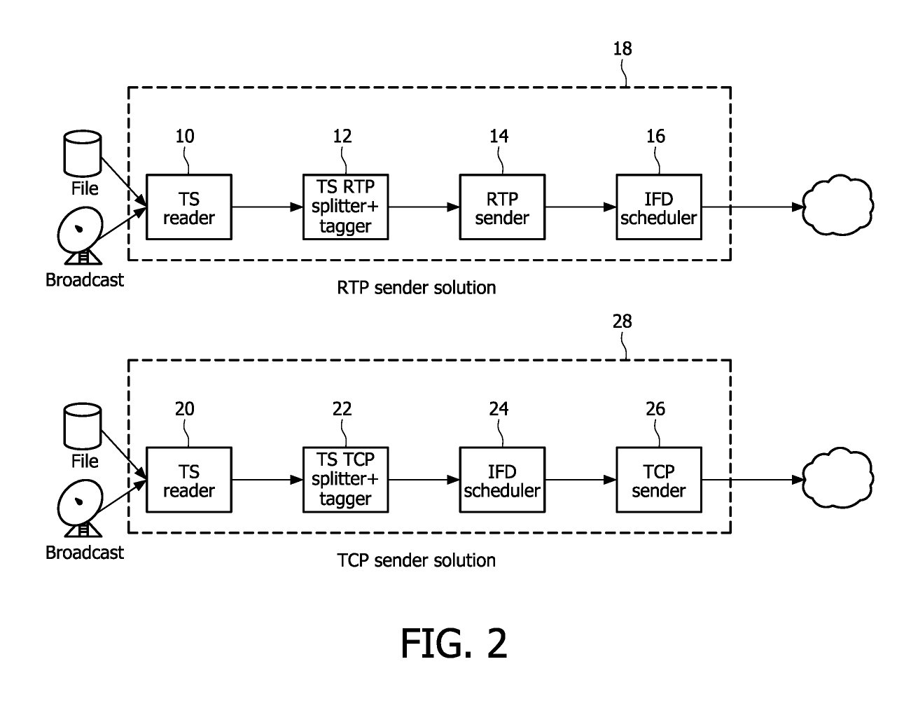

FIG. 2 shows schematically a sender solution using an RTP sender and a TCP sender, respectively.

Different embodiments of the present invention are possible. First, the embodiment for streaming with the RTP (Real-time Transport Protocol) protocol is described. The typical way, according to prior art, is to split the data stream into RTP packets comprising seven transport stream units, such as video (V), audio (A) and data (D) units (see 1, FIG. 1). The problem with this type of a splitting scheme is that, when IFD is being applied (for IFD, see “Adaptive Scheduling of MPEG Video Frames during Real-Time Wireless Video Streaming”, S. Kozlov, P. van der Stok, and J. Lukkien, Proceedings of WoWMoM, Jun. 13-16, 2005), complete RTP packets are dropped; and given a typical multiplexed transport stream structure where audio and video packets are interleaved, dropping an RTP packet may drop audio and data as well. Furthermore, parts of multiple frames may be comprised in one RTP packet; so multiple frames may be dropped at the same time (important and unimportant ones). Note that the terms used in FIG. 1 for the video units V1-V4 means that they belong to different video frames 1-4.

Therefore, a different splitting scheme is needed, as described below. During the splitting, a present unit is allocated to a new packet (in other words, the preceding RTP packet is finalized) if any of the following criteria is met:

1. If only one of the present unit and a directly preceding unit is a video unit.
2. If the number of units already allocated to a directly preceding packet is equal to a preset number.
3. If the present unit and the previous unit are both video-units, but they pertain to different video frames.

In the RTP case in FIG. 1, the data stream has been split into nine RTP packets according to the splitting scheme. Three of the splits made (3, 5 and 7) will be commented upon to illustrate each one of the criteria in the splitting scheme. At split (3) the present unit is a video unit V1 and the directly preceding unit is an audio unit A, so a split has been made according the first criteria. Thus, the audio unit A ends the preceding packet (in this case comprising only one unit) and the video unit V1 starts a new packet. Determining whether a transport stream unit is of type video, audio, or data is simply done by reading the transport stream header of each unit, where the PID (Packet Identifier) is stored.

The following eight units in the data stream are all video units V1, and the second criteria states that if the number of units already allocated to a directly preceding packet is equal to a preset number, in this case eight, a split (5) is made and the present unit is allocated to a new packet. Thus, the preceding video unit V1 ends the preceding packet and the present video unit V1 starts a new packet (in this case comprising only one video unit). Consequently, the packets will never comprise more than seven units.

At split (7), the present unit V4 and the previous unit V3 are both video-units, but they pertain to different video frames 3 and 4, so a split has been made according to the third criteria. Thus, the video unit V3 ends the preceding packet and the video unit V4 starts a new packet. Determining whether a video-unit starts a new frame is done by scanning for MPEG picture headers inside the payload of the video-units. The picture headers also give information about the importance of the frames (I, P, or B-frames).

The result of the splitting scheme according to the present invention is RTP packets that comprise either non-video packets or video packets. In case of video packets, only parts of one frame will be comprised within an RTP packet. This also means that RTP packets will be delivered which on average will have a size smaller than seven transport stream units. This results in less efficient usage of the network resources due to smaller packets and causes thus some overhead during transmission. For efficiency reasons the RTP packets should be as big as possible, so there is normally no reason to finalize packets too early. The present invention suggests the use of IFD where the video units to be processed have to be separated from the non-video units.

One way of increasing the average size of the packets, and thus reducing the overhead, is to pack non-video units together with I-frame video units, if they are adjacent to each other. Since they both are treated with the highest priority such packets will not be dropped. In FIG. 1 for RTP, if V1 is an I-frame and is followed by an audio frame A, then the split can be deleted between V1 and A.

The RTP packets resulting from the splitting scheme can then be tagged and fed to the IFD scheduler. An implementation of an RTP transmitter 18 is shown in FIG. 2. Several parts can be identified:

1. A TS (transport stream) reader 10, which reads the transport stream from a file or from broadcast
2. A TS RTP splitter and tagger 12, which splits the transport stream into RTP packets using the splitting scheme explained above and constructs the RTP headers. It also tags the resulting RTP packets, which comprise non-video or video units, as being non-video frames (audio or data), or video frames (more specifically, B-, P-, or I-frames)
3. An RTP sender 14, which sends the RTP-packets with the right timing to an IFD scheduler 16
4. An IFD scheduler 16, which sends the packets over a wireless network and performs the dropping according to the IFD algorithm when necessary. IFD uses the tags attached to the packets to determine which packets to drop when the network bandwidth is insufficient. Non-video packets are never dropped to avoid audio artifacts and loss of system data.

The IFD scheduler 16 may actually be placed before the RTP sender 14, as is the case for the TCP transmitter (see below).

Another embodiment of the invention uses the TCP protocol for streaming. The advantage of TCP is that it provides a congestion control mechanism and end-to-end feedback on the link bandwidth between sender and receiver, independent of the network topology (wired/wireless hops). On top of TCP, HTTP based streaming can be implemented. The disadvantage is that the real-time requirements are not taken into account. Due to TCP's retransmission mechanism when packets are lost, the stream will be slowed down when the input can be stalled (e.g. from a file), or if the stream cannot be stalled (e.g. live broadcast), buffers will overflow and losses will occur leading to artifacts. A proposed TCP transmitter 28 is shown in 2. It consists of the following components:

1. A TS (transport stream) reader 20
2. A TS TCP splitter+tagger 22. This component is similar to the TS RTP splitter in FIG. 2, with the big difference that it may produce chunks bigger than seven transport stream units (see the TCP case in FIG. 1), because TCP splits big chunks into smaller packets automatically.
3. An IFD scheduler 24. This scheduler will put the packets in a sending buffer with the proper timing. It also applies IFD by dropping frames from this buffer if it becomes full, indicating insufficient network bandwidth.
4. A TCP sender. This component tries to send the packets in the sending buffer to the network as soon as possible using TCP.

The location of the IFD scheduler 24 is to be noted here, which is different from the RTP solution. This is because the frames have to be dropped before they enter TCP (in the TCP sender 26), otherwise TCP will request retransmission of the dropped frames and dropping will not help. The TCP sender 26 will be slowed down when network congestion occurs, causing the sending buffer to get full. At this moment, the IFD scheduler 24 can detect this and perform the dropping of the frames.

The RTP splitter 12 and the TCP splitter 22 comprises a parser and a buffer (not shown). The splitters 12, 22 will parse the incoming transport units to see whether it is video or non-video and find the video frame boundaries, and will store them into the buffer. The buffer should be big enough to hold maximally seven transport stream units.

Note also that since the basic IFD scheduling algorithm has been left untouched, the IFD scheduler implementation can be used in a system supporting both transport stream streaming and elementary stream streaming. The latter is particularly useful for streaming of DVD content (after demultiplexing into video and audio elementary streams).

It should be noted that the above-mentioned embodiments illustrate rather than limit the invention, and that those skilled in the art will be able to design many alternative embodiments without departing from the scope of the appended claims. The present invention is not limited to the use of IFD, it also useful in all applications which require that the video units are separated from the non-video units, e.g. with other network scheduling techniques besides IFD. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

1. A method of splitting a data stream into packets, said data stream comprising video units and non-video units, the method comprising:
splitting said data stream into packets which comprise either only video units or only non-video units.

2. A method according to claim 1, wherein the splitting of said data stream comprises allocating a present unit to a new packet if only one of the present unit and a directly preceding unit is a video unit.

3. A method according to claim 1, wherein the splitting of said data stream comprises allocating a present unit to a new packet if the number of units already allocated to a directly preceding packet is equal to a preset number.

4. A method according to claim 1, wherein the splitting of said data stream comprises allocating a present unit to a new packet if the present unit and the previous unit are both video-units, but pertaining to different video frames.

5. A method according to claim 1, wherein the data stream comprises an MPEG transport stream.

6. A method according to claim 1, wherein the packets are of RTP or TCP type.

7. A computer program enabling the carrying out of a method according to claim 1.

8. A record carrier comprising a computer program as claimed in claim 7.

9. A device for splitting a data stream into packets, said data stream comprising video units and non-video units, wherein the device is arranged to split said data stream into packets which comprise either only video units or only non-video units.

10. A device according to claim 9, wherein the splitting of said data stream comprises allocating a present unit to a new packet if only one of the present unit and a directly preceding unit is a video unit.

11. A device according to claim 9, wherein the splitting of said data stream comprises allocating a present unit to a new packet if the number of units already allocated to a directly preceding packet is equal to a preset number.

12. A device according to claim 9, wherein the splitting of said data stream comprises allocating a present unit to a new packet if the present unit and the previous unit are both video-units, but pertaining to different video frames.

13. A transmitter comprising a device for splitting a data stream into packets according to claim 9, and means for transmitting said packets.

14. A method of transmitting video units and non-video units being comprised in a data stream, the method comprising:
splitting said data stream into packets which comprise either only video units or only non-video units;
transmitting said packets.
